(19) United States
(12) Patent Application Publication
(10) Pub. No.: US 2013/0211866 A1
(43) Pub. Date: Aug. 15, 2013

(54) PROJECT CHECKLIST AND TABLE OF CHANGES FOR PROJECT MANAGEMENT

(71) Applicant: Bank of America Corporation, (US)

(72) Inventors: Candace Gordon, Jacksonville, FL (US); Todd Lowney, Jacksonville, FL (US); Aruna Jonna, Channai (IN); Paul LeSage, Jacksonville, FL (US)

(73) Assignee: BANK OF AMERICA CORPORATION, Charlotte, NC (US)

(21) Appl. No.: 13/841,133

(22) Filed: Mar. 15, 2013

Related U.S. Application Data
(63) Continuation-in-part of application No. 13/186,632, filed on Jul. 20, 2011.

(51) Int. Cl. G06Q 10/06

(52) U.S. Cl. CPC G06Q 10/06313
USPC 705/7.15

(57) ABSTRACT

Systems, methods, apparatuses, and computer readable media associated with providing a web-enabled front end for production support processes. A project task system retains all the project details, production support details, and metrics details in an easy to use tool and a database. The project task system may provide task tracking for production support activities and efforts. The project task system may manage, track, and document all production support key deliverables, activities, and data elements with teams deploying solutions within enterprise data warehouse environments.

### RELATED APPLICATIONS

This application is a continuation-in-part application of U.S. patent application Ser. No. 13/186,632 filed Jul. 20, 2011 and is hereby incorporated by reference in its entirety.

### BACKGROUND

Efficient project management is an important aspect of many businesses. Efficient project management includes not only having people with the necessary skill set to perform the work, but also having a sufficient number of people. Often, businesses are reactionary and thus, ramp up staffing after projects have already come in. This may leave the business behind before the project has even begun and may lead to short cuts that may result in inferior work or delays.

Further, many conventional project management systems require identification of tasks associated with a project once the project is received. This may be time consuming and inefficient. In addition, many conventional systems provide little organization of duties and minimal oversight of the individuals completing tasks within the project. Accordingly, a project task management system with efficient identification of tasks, task tracking, and tracking of historical data would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, systems, devices, computer readable media and methods for an online, web-enabled project management tool. The project management tool may include a project checklist module, a project tracker module, a service level agreement module, a table of changes module, and a task updates module. The project checklist module may be configured to receive project information associated with a new project and identify a project type based on the project information. The project checklist module may further be configured to link a set of applications associated with the project information for the new project, wherein the project information is a service level agreement. The project tracker module may be configured to track and update the project information for the new project. The service level agreement module may be configured to electronically submit service level agreements, distribute service level agreements, and approve service level agreements. The table of changes module may be configured to generate a comparison table that tracks column and row level changes for service level agreement changes, additions, or decommissions. The table of changes module may also generate an audit trail of changes for service level agreements in the form of the comparison table. The task updates module may be configured to prompt creation of a new set of tasks for the project type and associate the new set of tasks with the new project and the service level agreement. The task updates module may further provide real-time information to view, trend, and track tasks, types of tasks, and the completion of tasks.

According to one or more other aspects, systems, devices, computer readable media and methods for tracking the resiliency of an application are provided. In some examples, the systems and methods may include providing an interface for managing recovery information for an application. The systems and methods may also include requesting recovery information via a set of questions presented to a user at the interface. The systems and methods may further include receiving the recovery information from the user via the interface and associating the recovery information with the application.

According to one or more other aspects, systems, devices, computer readable media and methods for managing a review of a service level agreement (SLA) are provided. In some examples, the systems and methods may include determining whether to initiate a review of the SLA and automatically initiating an SLA review in response to a determination to initiate a review of the SLA. The systems and methods may also include providing notification to a reviewer that the SLA is under review and receiving review information from the reviewer for the SLA review. The systems and methods may further include storing the review information such that the review information is associated with the SLA.

According to one or more other aspects systems, devices, computer readable media and methods for project task management and change advisory board tracking for evaluating changes to projects are provided. The method may include: 1) receiving, by a project system, project information associated with a project, wherein the project information is a service level agreement; 2) providing, by a project system, an interface that allows users to evaluate a set of changes associated with the project; 3) identifying, by the project system, a set of metrics relating to the set of changes and the project; 4) generating, by the project system, a comparison table that tracks column and row level changes for the project, wherein the comparison table provides an audit trail of the set of changes for the project; and 5) providing, by the project system, real-time information to view, trend, and track the set of changes and the project. The method may further include providing an email notification for the set of changes to the project and sending the email notifications based on the project information and an automated contacts summary that is linked to the project. The email notification may be an automatic initiation of email messages to provide notification of details, notices, and notes relating to the set of changes. The method may further include providing real-time information for the project information and further providing feedback based on the project information and an automated contacts summary that is linked to the project. The method may further include exporting a reporting document for activities performed via the change advisory board tracking.

Still other aspects of the systems and methods provided herein include storing data associated with tasks, projects. The historical data may be trended to aid in predictive analysis and determining staffing needs.

### BRIEF DESCRIPTION OF THE DRAWINGS

The present disclosure is illustrated by way of example and not limited in the accompanying figures in which like reference numerals indicate similar elements.

FIG. 1 illustrates an example operating environment in which various aspects of the disclosure may be implemented.

FIG. 2 illustrates an example system for receiving projects, identifying tasks and automatically assigning tasks according to one or more aspects described herein.

FIG. 3 illustrates one example method of receiving projects, identifying tasks and automatically assigning tasks according to one or more aspects described herein.

FIG. 4 illustrates one example user interface for displaying one or more tasks associated with a user according to one or more aspects described herein.

FIG. 5 illustrates one example user interface displaying one or more tasks associated with the project according to one or more aspects described herein.

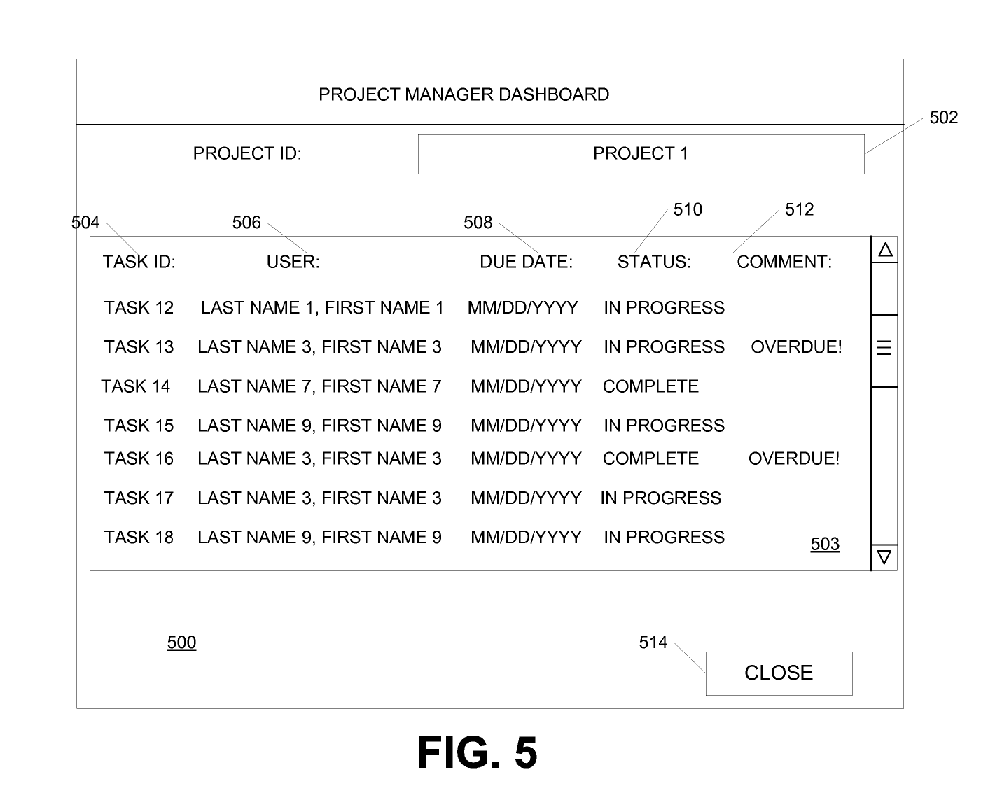

FIG. 6 illustrates one example chart displaying historical project and/or task data according to one or more aspects described herein.

FIG. 7 illustrates one example method of receiving projects, identifying tasks and automatically assigning tasks according to one or more aspects described herein.

FIG. 8 illustrates an example project task system for receiving projects, identifying tasks and automatically assigning tasks according to one or more aspects described herein.

FIG. 9 is an example of an implementation of a project tracking system for managing and tracking projects.

FIG. 10 shows a flow diagram of a process associated with project management according to one or more aspects described herein.

FIG. 11 shows a flow diagram of a process associated with tracking the resiliency of an application according to one or more aspects described herein.

FIG. 12 shows a flow diagram of a process associated with managing a review of a service level agreement according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

### General Description of the Computing Environment

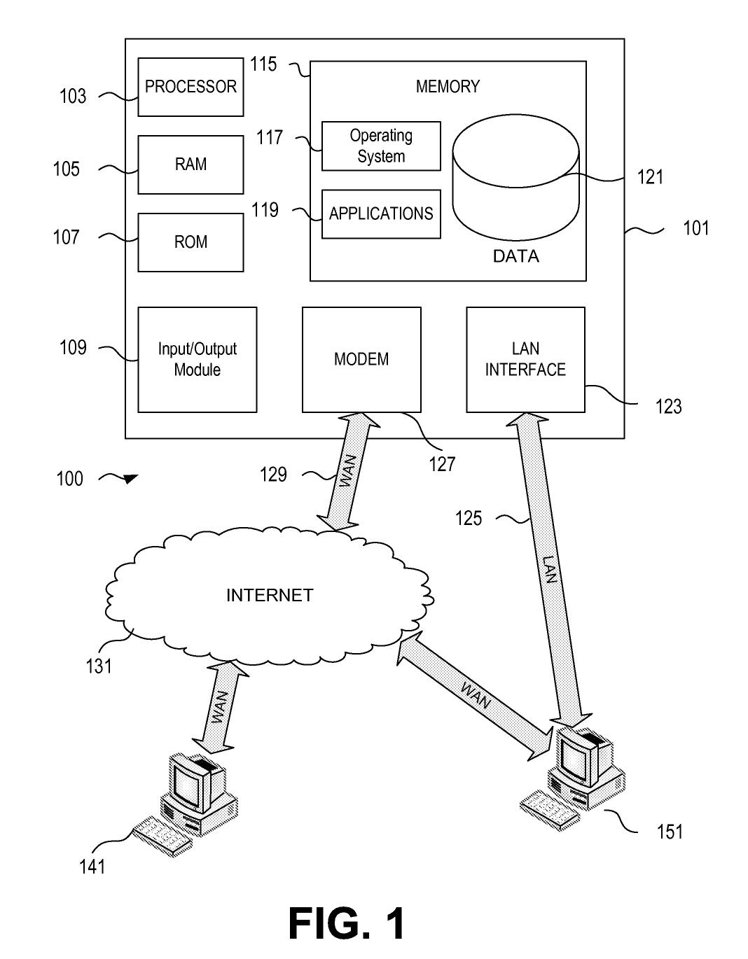

FIG. 1 illustrates a block diagram of a generic computing device 101 (e.g., a computer server) in computing environment 100 that may be used according to an illustrative embodiment of the disclosure. The computing device 101 may have a processor 103 for controlling overall operation of the device and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The computing device 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the server 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, and other mobile devices) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, and/or data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses or corporate entities, such as financial institutions or other entities, to aid in managing one or more projects, tasks associated with projects, and the like. For example, the systems, methods, apparatuses, and computer-readable media described herein may include receiving a project and identifying a plurality of pre-defined tasks associated with the project based on project type and/or characteristics of the project. The identified tasks may be assigned to users based on a role assigned to the user. The users may then complete the tasks and a project manager or other administrator may observe progress for one or more tasks from a user interface.

Additionally or alternatively, the systems, methods, apparatuses, and computer-readable media described herein may be used to maintain historical records of projects and/or project tasks to provide predictive analysis which may be useful for determining staffing needs. For instance, administrators may track when (e.g., what time of year or month) an influx of projects is generally received and may plan to increase staffing for that time period in advance. Additional details and examples are provided below. Further, although several examples used herein may include reference to a financial institution or projects associated with the financial institution, the systems and methods described herein may be used in a variety of industries (e.g., service and non-service industries), corporations, businesses, government agencies, universities, other types of organizations and the like. Nothing in the specification or figures should be viewed as limiting the invention to only use with banking or financial services related entities.

### Shared Platform Management Overview

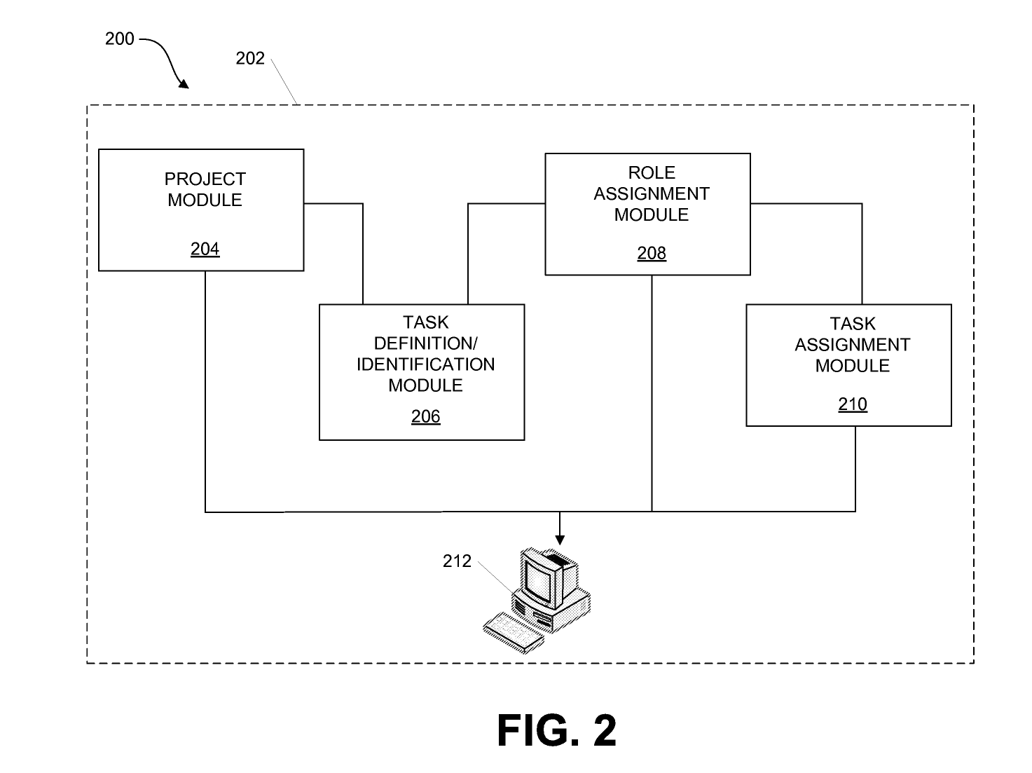

FIG. 2 illustrates one example project task system for receiving projects, identifying tasks associated with the project, and assigning those tasks according to at least some examples described herein. The project task system 200 may be part of or associated with an entity 202, such as the entity implementing the system. The entity 202 may be a business, corporation, university or other educational institution, government agency, and the like. In some examples, the entity may be a financial institution, such as a bank. For simplicity, the project task system 200 will be described in terms of a financial institution. However, nothing in the specification or figures should be viewed as limiting any of the features or aspects described herein to only banks or banking related issues. In some examples, the project task system may be external to or separate from the entity 202 (e.g., provided by or associated with a 3^{rd} party or outside vendor).

In some examples, the project task system 200 may be accessed via a network, such as the Internet. Additionally or alternatively, the project task system 200 may be accessed by systems internal to the entity 202, such as an intranet.

The project task system 200 may include a project module 204. The project module 204 may receive one or more projects or project specifications. In some examples, the project information may be input into the project module 204 via user input from computing device 212. Computing device 212 may include one or more computers (e.g., desktop computers, laptop computers, netbooks, computing terminals, and other computing devices) such as computer 100 of FIG. 1, cell phone, smart phone, and the like. Additionally or alternatively, the project and/or project information may be received at the project module 204 via an automated system in which defined projects are forwarded to the project task system 200 and are received at the project module 204.

In some examples, the project module 204 may identify a type of project received. For instance, based on the received project and/or project information, the project module 204 may associate a type of project with that project. The project type may aid in identifying one or more pre-defined tasks associated with the project. The project information may also include the type of platform being used, management or business group associated with the project and/or the type of technology associated with the project.

The project task system 200 may also include a task definition/identification module 206. In some examples, as a project is received, one or more tasks associated with the project may be defined. Some example tasks may include, for example, project document reviews, Operational Support Manual reviews, Service Level Agreement preparation, reviews and approvals, and the like. In some arrangements, the tasks may be defined by an administrator, such as a project manager and may be associated with the project or project type.

In some examples, the tasks may be defined initially, such as at an initial, one-time set up. That is, tasks may be defined the first time a project or project type is received. Any subsequent projects that are similar or of the same project type may then have tasks automatically identified for the subsequent project based on the pre-defined tasks. In some examples, the definition of tasks for all project types may be done all together, at one time, for instance, upon implementation of the project task system 200. Additionally or alternatively, tasks may be defined for each project type as the project is received. However, regardless of how the tasks are defined, the tasks will be stored and may be available for identification for subsequent projects.

The project task system 200 may further include a role assignment module 208. In some arrangements, a project may have a plurality of roles associated with the project or project type. Some example roles may include analyst, project manager, and/or team member. The role assignment module 208 may store data matching one or more roles to one or more tasks, such as the tasks defined or identified in the task module 206. For instance, when the project is received and the tasks associated with the project identified, the role assignment module 208 may match the identified tasks to one or more identified roles. The tasks may then automatically be assigned to one or more users having the assigned role, such as by the task assignment module 210.

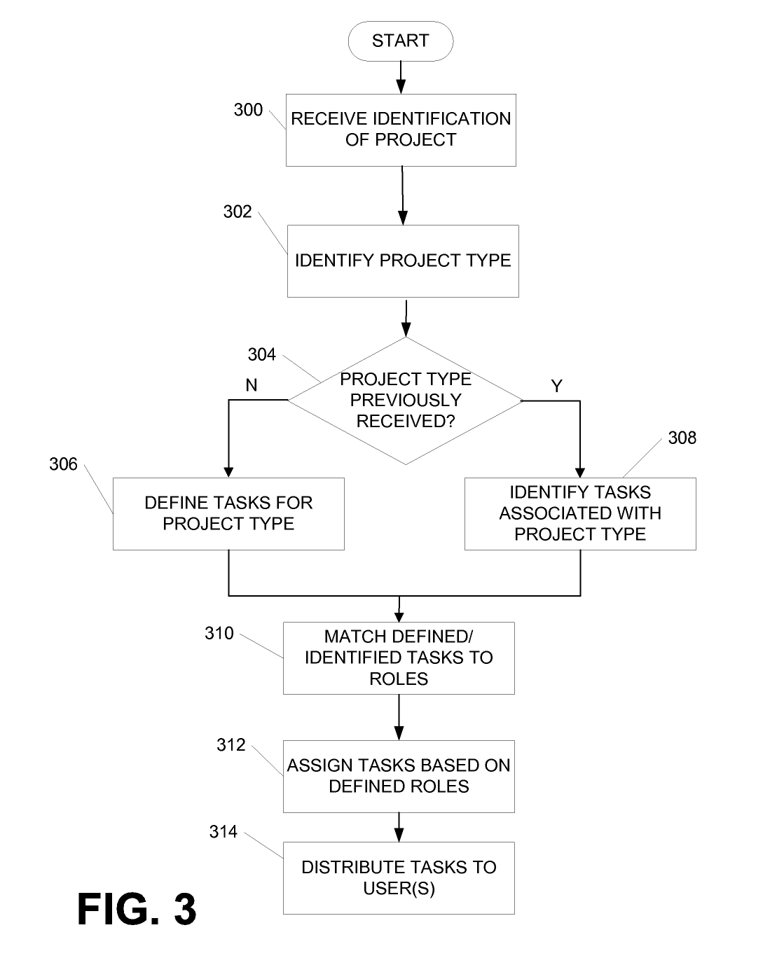

FIG. 3 illustrates one example method of receiving a project and assigning tasks according to one or more aspects described herein. In step 300, a project is received. Receipt of the project may include project data, characteristics or features of the project, and/or due dates for the project. In step 302, a project type is identified. The type of project may be determined from a predefined list of project types, in some examples. In other examples, the project type may be determined from user input received by, for instance, a project module (e.g., 204 in FIG. 2).

In step 304, a determination is made as to whether a project of the identified type in step 302 has been previously received. If not, one or more tasks associated with the project may be defined in step 306. The tasks defined may include those to complete the entire project or a portion thereof. For instance, the defined tasks may correspond to every aspect of the project such that completion of all tasks defined for the project type may coincide with completion of the entire project. In other examples, the tasks may correspond to a portion of the project.

If, in step 304, the project is a type which has previously been received, one or more tasks (e.g., predefined tasks) may be identified and associated with the project in step 308. In some examples, the tasks may be automatically associated with the project based on the received project information and/or identified project type. In step 310, defined/identified tasks may be matched to one or more roles associated with completion of the task. As discussed above, a plurality of roles may be identified that identify types of individuals needed or desired to complete one or more tasks (e.g., having the appropriate skill set, experience, and other similar types/needs). The role(s) may be matched to the defined or identified tasks in order to automatically assign the identified tasks to the particular role(s), as in step 312. Once the tasks have been assigned to the appropriate role(s), the tasks may be distributed to one or more user(s) having the appropriate designated role(s) in step 314.

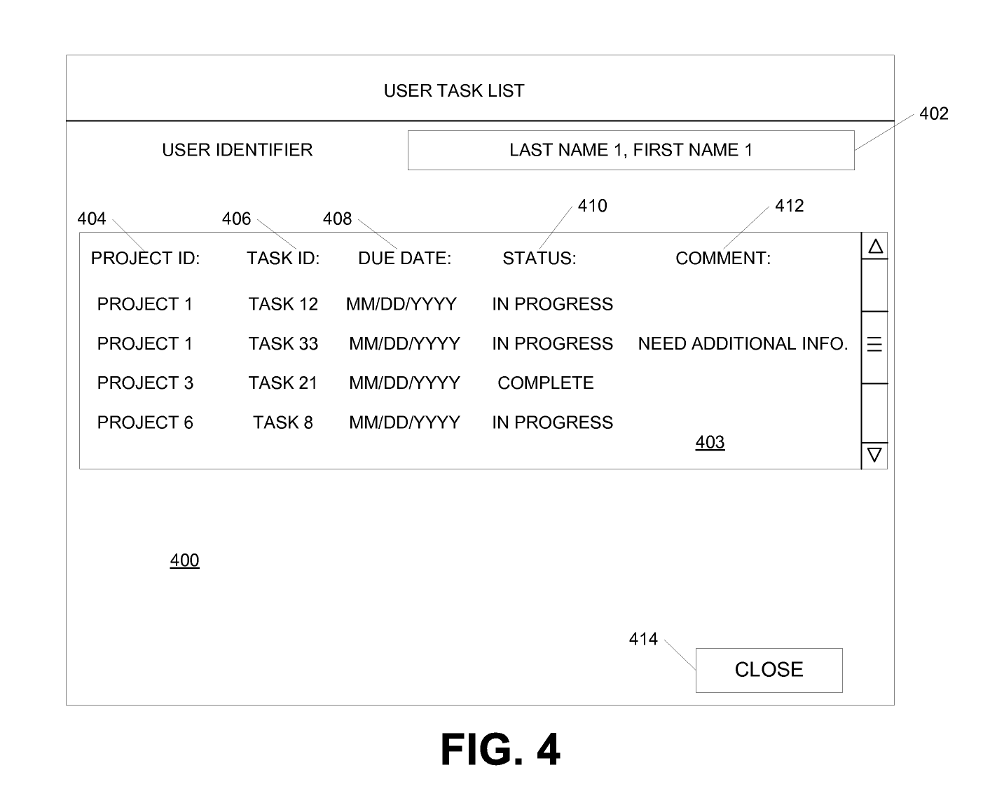

Once tasks are assigned to a user, the tasks may be managed by the user via a user interface, such as user task interface 400 in FIG. 4. The user task interface 400 may provide an overview of the tasks assigned to a particular user and may provide a “big picture” view of the tasks that are expected to be completed by that user. The interface 400 includes a user identifier region 402. The user identifier region 402 may identify the user associated with the tasks being displayed. The user may be identified by name, employee number, or other unique identifier.

The interface 400 further includes task list region 403. The task list region 403 may include some or all tasks assigned to or associated with the user identified in region 402. The task list region may include a project identifier in column 404. The project identifier 404 may identify the project associated with an individual task. The project may be identified by name, number, or other identifying features. The task list region further includes a task identifier column 406. The task identifier column 406 includes the tasks assigned to or associated with the user identified in field 402. The tasks may be identified by number, name, or other identifying features.

The task list region 403 may further include a due date for each task in column 408. The due date may be automatically generated for each task and may be based on predefined task duration guidelines that identify an approximate length of time to complete the task. The due date may also be based on an overall due date for the project.

The task list region 403 may further include a status column 410. The status column 410 may indicate whether the task is still being worked on (“in progress”) or has been completed (“completed”). In some arrangements, tasks may be filtered to display various tasks. In some examples, a filter may be a pre-defined search against existing data allowing a user to narrow the focus to the desired data. For instance, one or more filter criteria may be used to view tasks in-progress, overdue, completed, and/or all tasks assigned. The filter(s) may be pre-defined to permit controlled flexibility for viewing tasks and meeting a user's viewing needs. Column 412 provides a comment area for each task in which the user may insert additional information, and/or reminders.

The user may select a task from the list to obtain additional information about the task (e.g., via a pop-up interface) or to adjust the settings (e.g., mark complete and/or add comment) as desired. Further, a slider may be provided to scroll through additional tasks that may not be visible on the portion of the task list region 403 shown. The user may close out of the interface 400 by selecting “close” option 414.

The tasks associated with a project may also be visible to a project manager or other administrator, such as via dashboard interface 500. The dashboard interface 500 includes a project identifier in field 502. The project identifier field 502 may include the name or other unique identifier associated with the project. The interface 500 may further include project task field 503. The project task field 503 may include a list of tasks associated with the project in column 504. The tasks may be identified by a task identifier that may be a name, number or other unique identifier. Column 506 identifies the user to whom that task is assigned. The user may be identified by name, employee number or other unique identifier. Column 508 indicates the due date for each task and column 510 provides the status of the task. Column 512 is a comment column and may indicate that a task is overdue or on hold or various other comments may be provided. The user (e.g., project manager) may close out of the interface by selecting “close” option 514.

The dashboard interface 500 may permit the project manager or other administrator to obtain an overview of the status of the project and each task. For instance, the dashboard may indicate which tasks or users are overdue, which tasks are being worked on, whether a user is not responding, or other similar information. This may enable the project manager to anticipate issues with tasks, users, and/or deadlines, and take action early on in order to minimize the effect on the rest of the project.

The project task system may include storage of tasks, projects, and/or due dates. This information may be stored and historical trends may be produced from the data. These historical trends may aid in predictive analysis. For instance, the historical data may aid in identifying times of year when a higher than usual number of projects is received. For instance, if the historical information indicates that the month of September has brought a substantial increase in projects for the past 4 years, project managers may use that information to increase staffing for the current year as the month of September approaches to be better equipped to deal with the influx of projects. The predictive analysis from historical data may also indicate types of projects that may be coming.

These predictions based on historical data may aid in reducing risk associated with projects. For instance, if the entity is short staffed and an influx of projects is received, corners may be cut in order to meet deadlines. This may result in inferior work product, increased costs down the line and/or delays. However, the predictive analysis associated with this system and/or method may reduce or eliminate those risks by aiding the entity in being more prepared for projects.

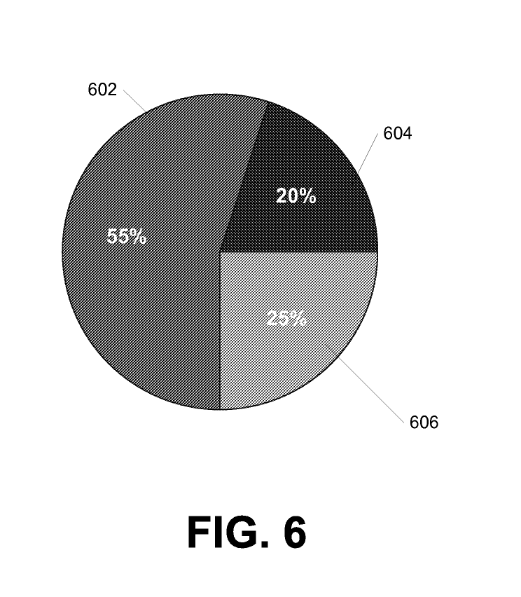

FIG. 6 illustrates one example graph that may be generated from historical data. FIG. 6 is pie chart indicating the types of projects that have come in in the first quarter of the past 3 years. For instance, pie slice 602 indicates projects of type 2, while slice 604 indicates projects of type 5 and slice 606 indicates projects of type 9. As shown in the graph, slice 602 is the largest percentage and thus more projects of type 2 have been received in the first quarter of the past three years than the other types of projects. This information may be used to increase staffing in the first quarter of the coming year with people having the skills needed to complete tasks associated with projects of type 2.

Although this is one example graph, various other types of graphs and information may be presented in graphical form from the historical data without departing from the invention.

### Web-Enabled Project Checklist

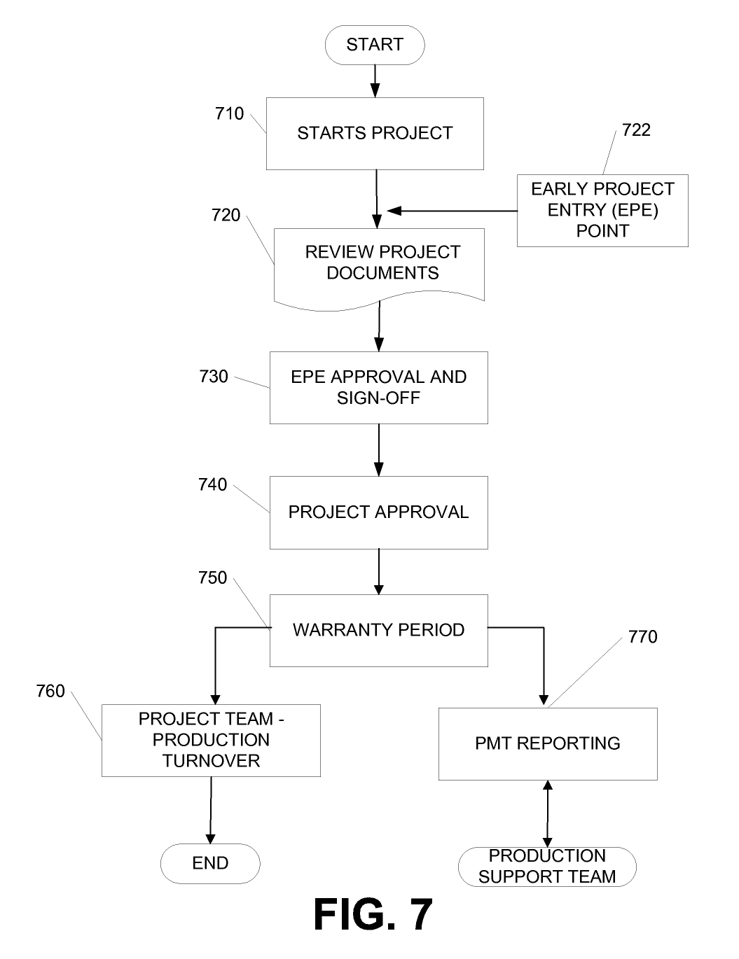

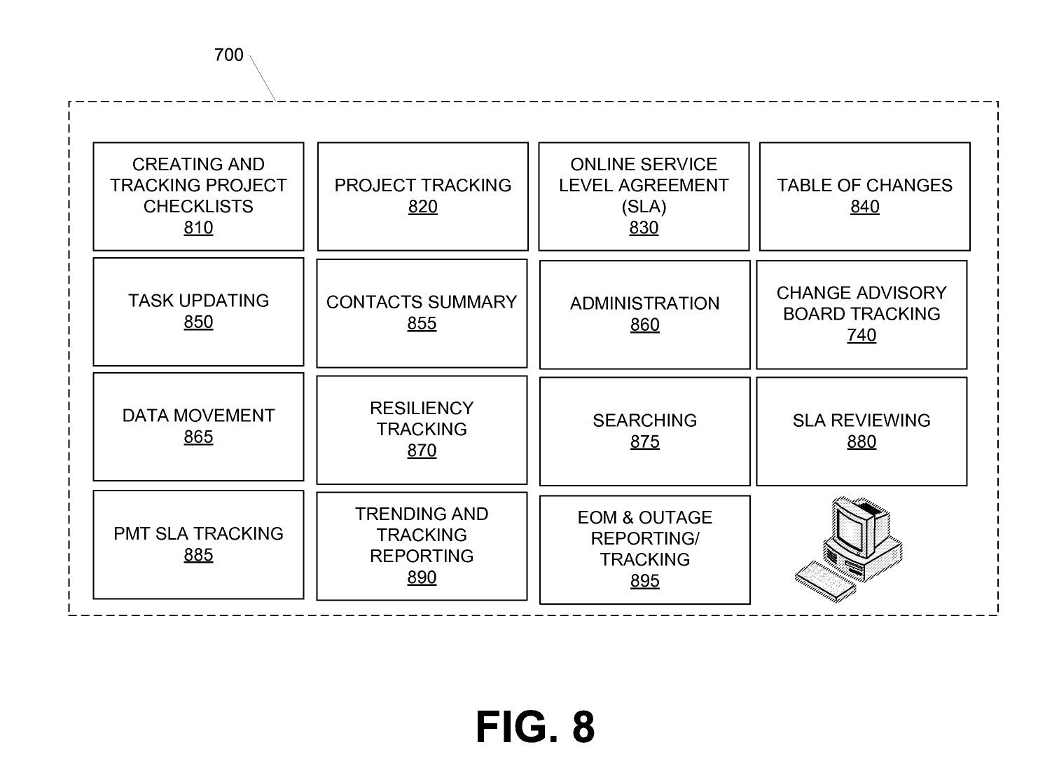

FIGS. 7 and 8 illustrate another example project task system in accordance with aspects of this invention. The project task system in FIGS. 7 and 8 illustrates a project task system 700 that provides a web-enabled front end for production support processes. The project task system 700 retains all the project details, production support details and metrics details in an easy to use tool and a database. The project task system 700 may provide task tracking for production support activities and efforts. The project task system 700 may manage, track, and document all production support key deliverables, activities and data elements with teams deploying ETL solutions within enterprise data warehouse environments. The projects may include service level agreements without departing from this invention.

Generally, the project task system 700 may perform a number of different functions without departing from this invention. For example, the project task system 700 may electronically create a project tasklist from a baseline of user generated answers to questions. Additionally, the project task system 700 may provide documentation of where the SLA originates from and linkages between the applications, such as by trending and tracking of the history and/or knowledge of how the data is sent through the system and how the data is provided to the system. The project task system 700 may also provide a linkage of applications from both internal and external sources as well as downstream sources and locations. In another embodiment, the project task system 700 may review a set of email notifications for the created checklist based on the profile of the project and an automated contacts summary that is linked through the project task system 700. The project task system 700 may electronically and automatically review, track, and trend the status of the submitted checklist. Additionally, the project task system 700 may capture details about new projects, control the type of projects that are received and accepted, and send notifications based on the profile of the checklist and the automated contacts summary that is linked through the system.

Generally, FIG. 7 illustrates a flow for an example project task system 700. At a first step, a project team starts the project 710. At a second step, the project team and systems may review the project documents 720, which may also include the early project entry point 722. At a third step, there may be early project entry approval and sign-off 730. At a fourth step, the project task system 700 may include Change Advisory Board (CAB) or project approval 740. Following the project approval, there may be a warranty period 750. From the warranty period 750, there may be project production turnover 760 and performance metrics reporting 770 by a production support team. As illustrated in FIG. 8, the project task system 700 may include modules that may include but are not limited to: creating and tracking project checklists 810; project tracking 820; online service level agreement 830; table of changes for service level agreements 840; and task updating 850.

The project task system 700 includes project checklist module 810 for creating and tracking project checklists which may include multiple different tasks. For example, a user may first logon to the early project engagement home page with an approved username and password. The username and password may be reflected by and contain the security that the user needs to perform their job function. The logon may be the entry point for the project team into the early project engagement automation website.

Creating and tracking project checklists using the project checklist module 810 may also include creating a project checklist. For example, the project checklist may be initiated, completed, and submitted for review. The project checklist may be the entry point for any project initiated into the early project engagement program/website. The project checklist may be a high-level checklist or questionnaire to give key information about the project requirements to the EPE team.

Creating a new project checklist may include various steps. First, the user may click an entry button, such as “EPE” on a toolbar. Next, the user may then fill in various fields in a form, such as request type, status, project number, and/or install date and then click on the “create new checklist” button. Request type may be used in initialing a project entry check listing or reviewing a project tracker. Status may one of the following: all—default; not yet assigned—during entry stage of the checklist; under review—the EPE analyst may be reviewing the checklist or project tracker; feedback provided—the project team has updated the checklist or tracker for the requested information; completed—checklist or project tracker is completed; awaiting information—the EPE analyst may have requested additional information from the project team; not applicable—the project tracker is not applicable for this checklist; draft checklist—saved checklist prior to submitting; open checklists—all the checklists except closed checklists; closed checklists—checklists under “completed status.” The install date may be the date of the project installation as per the agreement.

Next, an EPE project checklist may appear with a list of questions that need to be filled out by the project team. These questions may include questions about contact information. These questions may also include application information, such as application information, application manager, application name, support type, platform, and other similar-type information. The platform may be the technical platform in which the project is developed. Additionally, these questions may include a “yes/no” questionnaire regarding other additional details of the project. Following the completion of all forms and the answering or the questionnaire, the user may click the “submit” button to create the project checklist.

Once the project checklist is created, an email notification may be sent for the successful creation of the checklist to a list of primary and secondary names provided during the checklist creation. The email notification may be sent by the project task system 700 automatically to the list of primary and secondary names.

Creating and tracking project checklists at the project checklist module 810 may also include checking or verifying the status of a submitted project checklist. For example, a user may check or verify the status of a submitted project checklist. For example, a user may select “project entry checklist” from the request type option/pull-down menu and then select “all” under the status pull-down menu. The user may then select the “search” button. The project task system 700 may then list all of the active projects in a table that includes the columns of project number, Project Description, Date Initiated, and Status.

During the process, an EPE lead may review the project checklist and could potentially request more information. When the EPE lead requests more information, the project status may be listed as “awaiting more information.” Additionally, the project task system 700 may send out an email to the primary and secondary contact names stating that additional information may be required. The email may include steps to provide the necessary information for the project checklist.

Creating and tracking project checklists using the project checklist module 810 may also include displaying comments and allowing feedback for a given project. For example, the project task system 700 may display the EPE comments and allow the use to provide feedback throughout the methods and processes. First, the user may access the applicable checklist as described above to search for a given checklist. Next, after the project checklist is selected, an “All Comments” section may be displayed that displays all comments. These comments may include comments from the EPE team and the project team. The comments may be listed in a table listing the comment, the comment date, and the user that commented. New comments may be added by clicking “Add new comment” button. Once a comment has been added, the project task system 700 may provide a message showing that the comment was added successfully.

When an EPE team member wants to provide feedback, an EPE analyst may decide to create a tracker record such that the record would be created for the project number. Artifacts for a given project may be uploaded utilizing a link to an internal website. Artifacts may be those project related documents and/or production support documents that describe the project, application, and application functionality built to support the said application. The artifacts may then be attached to a file in the respective project by going into the edit mode. Once all artifacts are uploaded and the comments are provided in the comments section by the project team, the checklist status may be changed to “Feedback Provided” and again clicking the “Submit” button. When the update is successful, a message will confirm the successful update. An email will again be automatically sent to the EPE team stating that feedback was provided and comments were submitted for a given project number.

### Project Tracker

The project task system 700 also includes the project tracking module 820 which may include tracking and updating the project tracker. First, a user may access the project tracker from the main EPE page below by selecting “project tracker” from the request pull-down menu. A user may search for their specific project utilizing this main EPE search page or if the user knows the project number, install date, or similar items, the user may focus their search accordingly.

Generally, the project tracking module 820 may provide real-time information for EPE reviewer comments and provide feedback based on the profile of the project and the automated contacts summary that is linked through the system. Additionally, the project tracking module 820 may provide real-time information to view and analyze the tracker status and provide feedback. The project tracking module 820 may also provide real-time information to view and analyze the tracker comments for the “Technical and CACP” sections and “SLA and PMT” sections. Additionally, the project tracking module 820 may provide trending and tracking of the project and project/job performance over the life of the project.

Once a user is in the project tracker, there may be four different sections displayed: “General Info”, “Technical and CACP”, “SLA & PMT”, and “App SLA Summary.” Most of these values and fields may be carried over from the project checklist values. Additional markers in yellow or another color may be provided for the values that are editable by the project team in these different sections. Generally, the “General Info” section may be displayed as the default section. Other sections may be identified and displayed as the default section without departing from this invention. These sections may be selectable along a bar located along the side or top of the project task system 700 display.

Generally, by default, the sections will open in view mode. The user may select the “Edit” button to edit the fields in the corresponding section. To save any changes in the general information section (or any other section), the user may select the “Save” button.

The “General Info” section may include detailed general information about the project. For example, the “General Info” section may include information and details about the application manager, project manager, project primary contact, and project secondary contact. The contacts may be updated by typing the last name that may provide a drop down list that will then display the contact identification numbers to choose from. The “General Info” section may also include the project description and EPE document link fields that can be updated by the user and may be mandatory to be filled in. The “General Info” section may also include links to the EPE document and the IRM oversight tool which are both editable for the user to view and may be mandatory to be filled in. Additional items that may be included in the “General Info” section may include: application name, HLQ from project checklist, load platform, and/or artifacts needed from the project team.

The “Technical and CACP” section may include the comments and feedback information for the project. For example, the “Technical and CACP” section may include a display of a table of comments listing all comments that were provided by the EPE and project team. The comments table may include task name, comment details, comment date, and who made the comments. Additionally, the “Technical and CACP” section may also include the information about the install date and the environment fields that can be updated by the user. The “Technical and CACP” section may also include a section that is used for EPE internal purposes only. Additional items that may be included in the “Technical and CACP” section may include: EPE tracking date, CACP approved date, created date, modified date, modified by, and/or tracker status.

The “SLA & PMT” section may include information and details about the service level agreement and the performance metrics team (PMT) portion of the project. For example, the “SLA & PMT” section may include the first execution date, performance metrics reporting required, date and frequency of reporting fields that can be entered and/or updated by the user. Additionally, the “SLA & PMT” section may also include the information about the performance metrics reporting contact, turnover contact, and performance metrics contact phone. The performance metrics phone number may be automatically populated when the performance metrics contact details are filled in and may also be editable if required. Additionally, the “SLA & PMT” section may include a display of a table of comments listing all comments that were provided by the EPE and project team. The comments table may include task name, comment details, comment date, and who made the comments. The “SLA & PMT” section may also include a section that is used for EPE internal purposes only. Additional items that may be included in the “SLA & PMT” section may include: SLA review status field and a link to approved SLA documents with a link description.

The “APP SLA Summary” section may include information and details about the service level agreements (SLA) associated with a given application. The user may select the “APP SLA Summary” button and the “APP SLA Summary” page will display the SLAs associated with the application name selected in a drop down menu. By default, the project task system 700 may display the SLA associated with the first application listed in the drop down menu. The list of application names in the drop down may be dependent on the impacted applications chosen by the project team at the time the project checklist is created. This list of application names may also be edited at any time during the project timeline by an EPE analyst or EPE team member in the project tracker section.

The “APP SLA Summary” section may have various sections providing information and functionality. In the “Distribution SLA” section, the distribution SLA may be defined. In the “Supply SLA” section, the supply SLA may be defined, such as an operational system source for data that is loaded in a data warehouse. The supply SLA may be a file from a system of record or another application view/table. The “APP SLA Summary” may also include a “Job Schedule” wherein load schedule information is defined and includes jobs that are executed as part of the SLA. The load schedule information may include first job or last job details and miscellaneous job details. In the “Contact Summary” section, all contacts pertinent to the SLA may be defined. For example, PMT, production support, and system of record contacts may be specified in this section for a given SLA. The “Review SLA” section may be utilized once a project team submits the SLA for approval. The EPE analyst or EPE project team may utilize this section to review the SLA submitted by the project team. In the “Approve SLA” section, the EPE analyst will approve the SLA after all necessary approvals from stake holders are obtained.

Additionally, using the project tracking module 820, a user or EPE lead may view tracker status and provide feedback. Again, as was described previously, the user may search for the project on the EPE home page by selecting “project tracker” for request type and any other search information available, such as project number or install date, to further search for a given project. Once the user or EPE lead selects the project, the EPE lead may then review the project tracker and may request additional information. When more information is requested, the project status may be set to “awaiting more information” and the primary and secondary contacts may receive an email. The project task system 700 may automatically send a notification email to the primary and secondary contacts informing those contacts that further information is required by the EPE lead for their project tracker.

Additionally, the user may view EPE tracker comment and provide feedback using the project tracking module 820, and specifically in the “Technical & CACP” section. As was described previously, the user may search and select the project on the EPE home page by selecting “project tracker” for request type and any other search information available, such as project number or install date, to further search for a given project. Once the user or EPE lead selects the project, the user then may select the “Technical & CACP” section. The “View all Comments” portion of the “Technical & CACP” section will display all comments provided by the EPE analyst, EPE lead, or project team members. In this portion, the project team or use can provide their comments also by clicking on the “Add New Comment” button. If any other changes are made in this section, the “Save” button may be utilized to update and save the changes to this comments section. A confirmation or alert box may be utilized to confirm that the comments were added successfully. Additionally, all project artifacts may be uploaded via a link and identifying the project number and attach the file in the respective record. Once all the project artifacts are uploaded and the comments are provided in the comments section by the project team, the user may save the changes by clicking the “save” button and the project task system 700 will update the project status to “Feedback provided.” The project task system 700 will then automatically send out an email to the primary and secondary contacts and any other pertinent users or EPE project team to confirm and inform of the changes/comments added.

Additionally, the user may view EPE tracker comment and provide feedback within the project tracking module 820, and specifically in the “SLA & PMT” section. As was described previously, the user may search and select the project on the EPE home page by selecting “project tracker” for request type and any other search information available, such as project number or install date, to further search for a given project. Once the user or EPE lead selects the project, the user then may select the “SLA & PMT” section. The “View all Comments” portion of the “SLA & PMT” section will display all comments provided by the EPE analyst, EPE lead, or project team members. In this portion, the project team or use can provide their comments also by clicking on the “Add New Comment” button. If any other changes are made in this section, the “Save” button may be utilized to update and save the changes to this comment section. A confirmation or alert box may be utilized to confirm that the comments were added successfully. Additionally, all project artifacts may be uploaded via a link and identifying the project number and attach the file in the respective record. Once all the project artifacts are uploaded and the comments are provided in the comments section by the project team, the may save the changes by clicking the “save” button and the project task system 700 will update the project status to “Feedback provided.” The project task system 700 will then automatically send out an email to the primary and secondary contacts and any other pertinent users or EPE project team to confirm and inform of the changes/comments added.

### Online Service Level Agreements

The project task system 700 also includes the online SLA entry module 830 which may include the functionality of distribution of SLAs, supply of SLAs, job schedules, contact summary, and table of changes. Additionally, within the SLA entry module 830, SLAs may be submitted for review.

The online SLA entry module 830 may include various capabilities and perform different functions without departing from this invention. The online SLA entry module 830 may provide a linkage of jobs to SLAs, for example, linking the jobs to the SLAs while providing proper ownership and repeatability based on the profile of the project and the automated contacts summary that is linked through the project task system 700. This linking of jobs to the SLAs allows trending and tracking of SLA performance over time to provide predictive analysis of when future SLAs may be late or off schedule. The online SLA entry module 830 retains all comments from all users for the SLAs and follow-up items and tasks. The online SLA entry module 830 provides an online capability to add/update/delete information in various portions of the project task system 700, such as Distribution SLA, Supply SLA, Job Details, and Contact Information. The online SLA entry module 830 provides an online capability to submit SLAs for approval utilizing electronic signatures which helps provide trending and tracking capabilities for SLA approval and keeps track of time and role with complete accountability and responsibility. The online SLA entry module 830 also may provide trending and tracking and analysis for the number of SLAs approved and negotiated. The trending and tracking of submitted SLAs and reviewing SLAs allows the online SLA entry module 830 to build efficiency models for staffing future projects properly and automates the staffing with the contact summary. The online SLA entry module 830 may also provide real-time information to view SLA review comments provided by the EPE analyst.

The online SLA entry module 830 of the project task system 700 may include the distribution of SLAs. Within the distribution of SLAs, a user may add an SLA, update an SLA, delete an SLA, and edit the frequency of an SLA. From the project tracker, a user may navigate to the “APP SLA Summary” section as was described above. From this section, to update or delete an existing SLA, the user may select the SLA from the list. The user may delete the SLA by selecting the “Delete” button. The user may edit the SLA by selecting the “Edit” button. The user may add an SLA by selecting the “Add” button.

For adding a new SLA, a user will select the “Add” button on the “APP SLA Summary” section page. The project task system 700 may then display a number of fields to be filled in by the user. The following fields may be included: SLA Name—new SLA name; Calendar Type—choose one option from the drop down menu; Holiday Process Code—holiday indicator; PMT Reporting—does this SLA need to be reported to PMT? (yes or no); Extract, Transform and Load (ETL) Technology—choose from drop down, for example mainframe, datastage, or other options; ETL Environment—based on the type of ETL technology chosen, the ETL environment may be prepopulated and the user will select one option from the drop down menu; Teradata Environment—what is the Teradata platform, for example, VA7, TX10, and other platforms and the user will select one option from the drop down menu; First Execution Date—first date of execution of this new SLA in production; Expected Start Time—expected start time of processing; and Expected End Time—expected end time of processing. Once all the mandatory fields are completed and provided, the user may then click “Save” to commit the changes made in the distribution SLA section.

Upon saving of these details, the project task system 700 may ask for the distribution type. The distribution type may be either “View” in which the application loads data to Views or “Extract” in which the application extracts data to a file. If the user selects “View”, then the user may then be required to specify the distribution database name, distribution view/table name, and retention period. Upon completion of these fields, the user may then click “save” to save the distribution SLA. If the user selects “Extract”, then the user may be required to specify a number of mandatory fields in this section, such as “Extract File Name”, “File Type”, “Delivery File Name”, “Retention Versions”, “Source Location”, “Delivery Destination”, “Transmission Type”, and/or “Trigger Job.” Upon completion of these fields, the user may then click “save” to save the distribution SLA.

For editing or updating a new SLA, a user will select the “Edit” button on the “APP SLA Summary” section page and select an existing SLA to update/edit. The project task system 700 may then display the existing information and fields for an existing SLA. The user may then update or edit any of the existing information and fields for an existing SLA. After the user has completed the edits, the user may then select the “Save” button and the project task system 700 will update those details in for the distribution SLA.

For deleting an SLA, a user will select the “Delete” button on the “APP SLA Summary” section page and select an existing SLA to delete. The project task system 700 may then delete the existing SLA.

The online SLA entry module 830 of the project task system 700 may include the distribution of SLAs which includes adding or editing the frequency of an SLA. In designating a frequency, there may be two different frequencies, normal run day and SLA run day. Normal run day indicates the day the jobs will execute on a given platform. SLA run day is the day the data needs to be delivered to the data consumers. For example, the jobs may be schedule to begin daily (Monday-Saturday) at approximately 10 PM. The SLA delivery of data is the next morning at 8 AM. In this example, the normal run day frequency is Monday-Saturday and the SLA run day frequency is Tuesday-Sunday. The SLA frequency may be displayed in daily, weekly, or monthly frequency displays. Once the normal run day and the SLA run day details are provided, the user may select “Done” to complete this action and save these settings. The SLA frequency may be updated at any time in the future.

The online SLA entry module 830 of the project task system 700 may include the supply SLA function. Within the supply SLA function, a user may add a supply file, add a supply application, and edit a supply file/application. From the project tracker, a user may navigate to the “APP SLA Summary” section as was described above. From this section, the user may first select the application name, then for the chosen application name, the project task system 700 will display the SLAs and the user may select the SLA for which the user wants to update/define supply SLA, and then the user may click the “Supply SLA” button. The user may then select “Add File” or “Add Application.”

To add a file for the Supply SLA function of the online SLA entry module 830 of the project task system 700, the user may select the “Add File.” First, in the “Supply File Details” portion, the user may provide the supply name, the system of record name (SOR), holiday process, calendar, frequency, technology, and/or environment. Additionally, the user may provide the frequency of the file and file arrival SLA times. The frequency may be input as was described above. When the user is completed with the above inputs, the user may select “Done” and the “Update” to update the supply SLA file. Next, in the “Add/Edit/Delete Supply” files portion, the user may provide the supply file details such as Delivery File Name, File Type, Delivery Environment, and other similar details.

To add an application for the Supply SLA function of the online SLA entry module 830 of the project task system 700, the user may select the “Add Application.” A supply application may be an application used for loading to tables referenced in the added and/or modified distribution SLA. First, the user may choose the Supply Application. Based on the chosen application name, the project task system 700 will display SLAs and the user may select the SLA from the drop down. Next, the project task system 700 may be displayed and user may select and create the supply SLA by clicking the “Create Supply SLA” button. The user may also select the required views from the list “Supply Views Available” and click the “Add” button.

The online SLA entry module 830 of the project task system 700 may include the job schedule function. Within the job schedule function, a user may add a job, update a job, and delete a job. From the project tracker, a user may navigate to the “APP SLA Summary” section as was described above. From this section, the user may first select the application name, then for the chose application name, the project task system 700 will display the SLAs and the user may select the SLA for which the user wants to update/define supply SLA, and then the user may click the “Job Schedule” button.

At the “Job Schedule” page of the SLA entry module 830, the project task system 700 may display a page to add new job by clicking the “Add” button. On the Job Details section, the user may provide all the mandatory fields in the “Add Job Details” section and then click “Save” to commit the changes. The Add Job Details section may include a list of jobs added. Once all the required list of jobs are added using the “Add” button, all added jobs may be displayed.

To update a job schedule, at the “Job Schedule” page of the SLA entry module 830, the project task system 700 may display a page listing all existing job schedules. The user may select the job schedule that needs to be updated, update the job and/or fields that need to be updated, and then click “Update” to update the job schedule.

To delete a job schedule, at the “Job Schedule page of the SLA entry module 830, the project task system 700 may display a page listing all existing job schedules. The user may select the job schedule to be deleted and then click “Delete” to delete the selected job schedule.

The online SLA entry module 830 of the project task system 700 may also include submitting the SLA for review module. Once the project team has reviews all the changes performed as part of the project tracker, the project team may submit the SLA for EPE analysis review/approval. From the project tracker, a user may navigate to the “APP SLA Summary” section as was described above. From this section the user first selects the application name, then for the chosen application name, the project task system 700 will display the SLAs and the user may select the SLA for which the user wants to submit for review. The user may then select the “Submit for SLA Review” section, which may submit the updates for the application chosen at the top of the page. If there are multiple applications with SLA changes, the user may need to submit for review for each application associated with the project tracker.

The project task system 700 may then automatically trigger and send an email to the project team primary/secondary contact and EPE analyst for the new SLA added or an existing SLA updated. Additionally, the Application/SLA Review status may be automatically updated and changed to “Under Review.” Additionally, all “APP SLA Summary” sections may be un-editable by the project team.

Once the project team submits the SLA for review, the EPE analyst may review the SLA and provide review comments. The project task system 700 may automatically send an email notification by the EPE team to the project team for the EPE analyst comments. The APP/SLA Review status may be “Awaiting Information” (pending project team response for the EPE analyst comments). The SLA section may be editable for the project team if needed or required. Additionally, the EPE analyst review comments may be viewed in the APP SLA Summary page. The project team may provide their feedback in the “Review Comments” section in the APP SLA Summary page and click “Add” to add the comment. The project team may then again submit the SLA for review. Once the project team submits feedback, the project task system 700 automatically changes the Application/SLA Review status to “Feedback Provided.” This review process may continue until the entire review is complete and when the EPE analyst finishes the review tasks the SLA, the status may then be updated to “Review Completed.” Additionally, the EPE analyst may e-notify all the stake holders for their approval. Once all stakeholders approve the SLA, the Application/SLA Review status may be changed to “Approved.”

### Table of Changes

The project task system 700 also includes the table of changes module 840 for service level agreements. The table of changes module 840 is specifically related to service level agreement changes, additions, or decommissions. The table of changes module produces efficiency within the SLA review cycle and provides an audit trail of changes for the SLA. The table of changes may be utilized to compare an older version of the SLA versus the new version of the SLA. The table of changes may provide a field-by-field, row-by-row comparison to reduce the review time from hours to minutes. This efficiency may lead to great productivity gains for the EPE project team and giving them the necessary resources to complete SLA reviews in a timelier manner with a reduction in missed changes. For example, a project tracker for the SLA may involve changes to an existing SLA or adding a new SLA or deleting a SLA. There may be 80 or more different elements or fields attached to an SLA and any field can change as part of a project tracker. The table of changes section may display the summary of changes that are made as part of this tracker under each section. The table of changes section provides a comparison between the approved existing SLA vs. changes to the SLA as part of the current project tracker.

The user may select the “APP SLA Summary” button and the “APP SLA Summary” page will display the SLAs associated with the application name selected in a drop down menu. The project task system 700 may display the available table of changes for the SLAs modified under the selected application name as part of the project tracker. A user may select the SLA ID by checking a box and clicking “View.”

The project task system 700 may then display the specific table of changes to the SLA ID selected. The table of changes may include a color pattern that represents the changed state. For example, green may stand for edited fields—updated to existing details; blue may stand for new—new details added; orange may stand for deleted fields—those fields where the existing details are deleted. The table of changes may include a table of the existing state vs. the changed state. The table of changes may be expanded so that a user may be able to view the specific fields within the SLA that may have changed. For example, the “Click here to Expand: Distribution SLA” by default may expand the SLA details section displaying the SLA details. The table of changes may include all sections of the project tracker, such as SLA details, supply details, job schedule, and contact summary. Each of these sections may include fields that may have changed or been edited. To view the Supply Details, the user may select the Supply Details tab. When a user selects the Supply Details tab, the project task system 700 displays the supply information of the SLA. Additionally, when a user selects the Job Schedule tab, the project task system 700 displays the job details of the SLA. Similarly, when a user selects the Contact Summary tab, the project task system 700 displays the contact person details of the SLA.

### Task Updating

The project task system 700 may also include task updates module 850. The task updates module 850 may provide real-time information to view, trend, and track tasks, types of tasks, and completion of tasks. The task updates module 850 may also provide real-time information to view and update pending tasks. Additionally, the task updates module 850 may provide email alerts for notification type of tasks, “SLA Review Completed”, and “All Review Completed” based on the profile of the project and the automated contacts summary that is linked through the system.

Depending on the type of project and based on the platform, there may be pre-defined tasks that are assigned to a project tracker. These pre-defined tasks may be used extensively by the EPE team to track the progress of each task during the life cycle of the tracker process. There may be different tasks status, such as: initial—default; in process—currently the task is being worked on; pending feedback—pending feedback from the project team; complete—task is complete; not applicable—task is not applicable. There may be two different types of tasks: effort tasks and notification tasks.

Effort tasks are those tasks that involve few man hours. The EPE lead may set a due date for this task completion. The EPE lead may monitor the status of the tasks and the number of hours spent on that task. Once the due date is reached, if the status of the task is not complete, a batch process from the project task system 700 will send out a reminder notification email pertaining to the task. If no response is received, and the task status is in pending or past due status for more than two reminder notification, the project task system 700 may automatically trigger/send out an escalation email to the project team primary and secondary contacts.

Notification tasks are tasks that normally require minimal effort. The “Send Notification” button is used to send out an email about completion of this task. Project team involvement is not needed for the notification of the type tasks. The project team does not have to update the task field values, however, the project team would have to act upon the email that the project team receives as part of the notification process by the EPE team. All of the notification tasks are used by the EPE team to trigger notifications to the project team.

The task updates module 850 of the project task system 700 may include the display of pending tasks. As was described previously, a user may search for a project on the EPE home page by selecting “project tracker” for request type and any other search information available, such as project number or install date, to further search for a given project. Once the user or EPE lead selects the project, the EPE lead may then review the project tracker. The tasks may be displayed in the Technical & CACP and SLA & PMT sections of the tracker. The project team intervention may be needed for the task when the status reflects “Pending Feedback.” Only “Pending Feedback” tasks may be displayed for a project team under the “Tasks” section. The project task system 700 may automatically send an email for “Awaiting Information” status and/or status changes.

The task updates module 850 of the project task system 700 may include the updating of pending tasks. Additionally, as was described previously, a user may search for a project on the EPE home page by selecting “project tracker” for request type and any other search information available, such as project number or install date, to further search for a given project. Once the user or EPE lead selects the project, the EPE lead may then review the project tracker. The tasks may be displayed utilizing the “Technical & CACP” and/or “SLA & PMT” sections. The user may go to the applicable section based on the tasks that the user desires to update. First, the user selects the task that the user wants to update. Next, the user may utilize the comments section to update the task comments and then click add to add those comments. The user may then update the project tracker status to “Feedback provided” which may then notify the EPE team through an email alert that is automatically triggered and sent by the project task system 700.

The task updates module 850 of the project task system 700 may include an email alert for the notification tasks. The notification tasks normally do not require a substantial effort. The “Send Notification” button is used to send out an email regarding the completion of this task by the EPE analyst. The project team involvement is not needed for the notification type tasks. The project task system 700 may send out an email to project team primary and secondary contacts as required for this email alert.

The task updates module 850 of the project task system 700 may include an email alert for the SLA review completed. The project task system 700 may automatically send an email alert for SLA approval to the project team when the EPE analyst completes the SLA review and approves the SLA.

The task updates module 850 of the project task system 700 may include an email alert for “all review completed.” The project task system 700 may automatically send an email alert for “all review completed” to the project team when the EPE analyst completes the review of the project tracker. The “all review completed” may be the end of the tracker process and the tracker status may then be in “Complete.”

The all review completed notification tasks normally do not require a substantial effort. The “Send Notification” button is used to send out an email regarding the completion of this task by the EPE analyst. The project team involvement is not needed for the notification type tasks. The project task system 700 may send out an email to project team primary and secondary contacts as required for this email alert.

The project task system and method described herein may further be customizable in order to adapt to various industries or changes. For instance, the types of tasks, may be modified as needed to include additional tasks and/or remove redundant tasks. In another example, predefined durations for tasks (e.g., for generating automatic due dates) may be revised based on historical data indicating that more or less time may be needed for those tasks.

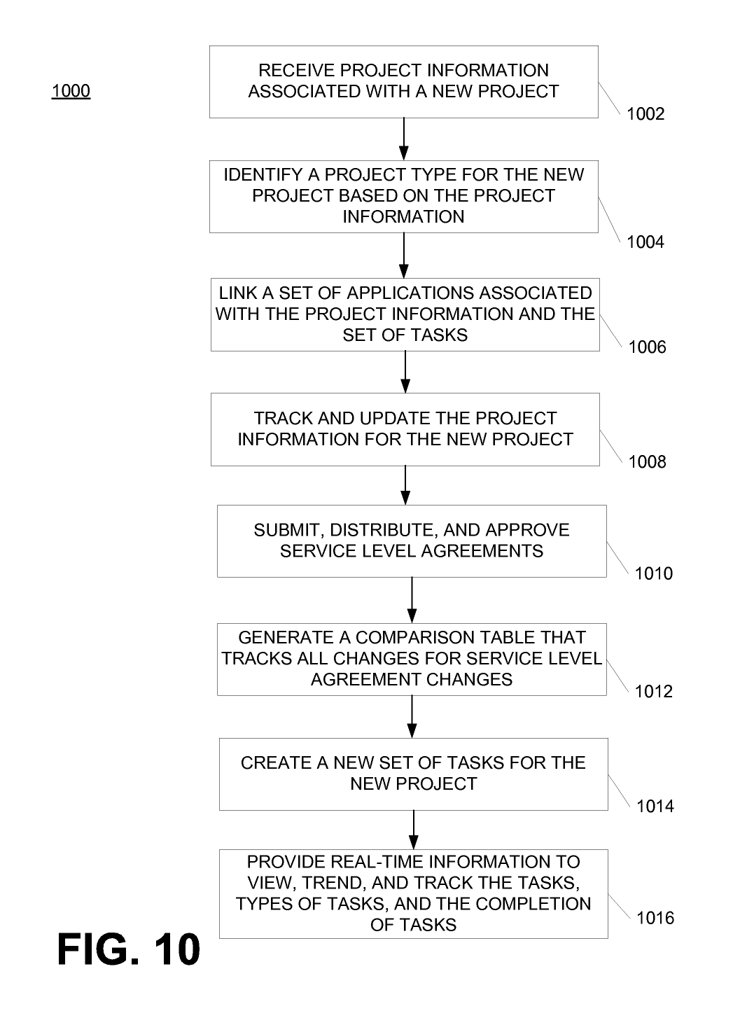

FIG. 10 illustrates a flow diagram of an example process in accordance with aspects of this invention for project management 1000. The example project management process 1000 may be implemented by one or more systems, devices, or computer readable media as described herein. The order of the steps depicted in FIG. 10 may be rearranged, one or more steps may be repeated in sequential and/or non-sequential order, and/or one or more steps may be omitted. Further, other steps may be added to the process 1000.

The project management process 1000 includes a step 1002 of receiving project information associated with a new project. The project management process 1000 may also include another step 1004 that includes identifying a project type for the new project based on the project information. The project management process 1000 may include another step 1006 of linking a set of applications associated with the project information and the set of tasks. The project management process 1000 may also include a step 1008 of tracking and updating the project information for the new project. The project management process 1000 also includes a step 1010 of submitting, distributing, and approving service level agreements. The project management process 1000 may also include a step 1012 of generating a comparison table that tracks all changes for service level agreement changes. The project management process 1000 may also include a step 1014 of creating a new set of tasks for the new project based on the project type and associating the new set of tasks with the new project and the service level agreement. The project management process 1000 may also include a step 1016 of providing real-time information to view, trend, and track the tasks, types of tasks, and the completion of tasks.

### Contacts Summary Module

The project task system 700 also includes the contacts summary module 855 for presenting messages relating to projects and tasks. The contact summary module 855 may present an interface for displaying a list of contact messages. The contact summary module 855 may automatically create the list of contact message for display. The contact messages may reside at one or more databases of the project task system 700 as well as at internal or external sources. Accordingly, the contact message list may be linked with the databases of the project task system 700 as well as with internal sources and external sources. The contact messages may be, for example, email alerts generate and provided by the project task system 700 for notification, prompting, and reporting of project activities.

The online SLA entry module 830 of the project task system 700 may include the contact summary module 855. The contact summary module 855 may provide a centralized location for all contacts pertaining to a selected SLA that can be specified like PMT reporting, system of record, and production support contacts. Within the contact summary module 855, a user may add a contact, update a contact, and delete a contact. From the project tracker, a user may navigate to the “APP SLA Summary” section as was described above. From this section, the user may first select the application name, then for the chosen application name, the project task system 700 will display the SLAs and the user may select the SLA for which the user wants to update/define the contact summary, and then the user may click the “Contact Summary” button.

At the “Contact Summary” page of the SLA entry module 830, the project task system 700 may display a page to add new contact by clicking the “Add” button. The contact details may be obtained by providing the last name in the “Enter Contact Name” filed and by clicking the “Search” button. On the contact summary section, the user may provide all the mandatory fields in the “Add Contact summary” section and then click “Save” to commit the changes. The Add Contact Details section may include a list of contacts added. Once all the required list of contacts are added using the “Add” button, all added contacts may be displayed.

To update a contact, at the “Contact Summary” page of the SLA entry module 830, the project task system 700 may display a page listing all existing contacts. The user may select the contact that needs to be updated, update the contact and/or fields in the contact summary that need to be updated, and then click “Update” to update the contact.

To delete a contact, at the “Contact Summary” page of the SLA entry module 830, the project task system 700 may display a page listing all existing contacts. The user may select the contact to be deleted and then click “Delete” to delete the selected contact.

### Administrative Functions

The project task system 700 also includes the administration module 860 for controlling security to the system and various applications. The administration module 860 controls the security to the system and applications by authenticating an administrator via security/login function point security. Function point security may allow a manager to decide what team (e.g., group, table/corporate domain) a user goes into, which may then provide a certain level of accessibility. Accessibility may be based on the team the user is in rather than based on a specific application. The project task system 700 may then provide access based on the type of security and function point security is associated with that team. The administration module 860 may also be used to control the function point security through a centralized interface and a security/function point security table. The administration module 860 may also be used to add or edit LOB alignment, which may allow managers and leaders to change alignments without impacting lower level data. The administration module 860 may further provide a calendar, and additions or updates to calendar information may allow the tracking of events and/or holidays utilizing a centralized calendar that is linked to applications and systems of the project task system 700.

### Change Advisory Board (CAB) Tracker

The project task system 700 also includes the change advisory board (CAB) tracking function 740 for evaluating changes to projects. The CAB tracking module 740 may provide an interface that allows users to evaluate changes to projects, share metrics relating to projects, provide notes, view an audit trail of changes including which individuals made the changes, and the like. The CAB tracking module 740 may also be configured to evaluate changes to projects via trending, tracking, and analysis. The project task system 700 may also include an email notification system the CAB tracking module 740 may utilize to automatically provide notifications of changes based on the CAB and/or the profile of the project. For example, the CAB tracking module 740 may automatically initiate email messages to provide notification of details, notices, and notes relating to project changes. The project task system 700 may also include a reporting system, and the CAB tracking module 740 may be configured to export a reporting document (e.g. a spreadsheet document) for activities performed via the CAB tracking module.

The CAB tracking module 740 may provide an interface for searching for change records based on a variety of criteria, e.g., docket date, docket type, CAB number, issue ticket number, status, UAT install date, production install date, level of urgency, and the like. The CAB tracking module may provide a search result list at the interface as, e.g., a table. Columns of the table may display various types of information such as the information identified above as well as CAB description, CAB notes, SLA notes, AR decision, promote information, change platform information, and data analysis environment. A user may select one of the search results in the table, and the CAB function 740 may provide a more detailed view of the change record at the interface. The detailed view of the change record may include the information identified above as well as the nature of the request, a description, board notes, EPE comments, SLA comments, notes, and high level metrics. High level metrics may include, for example, review effort, pended CAB, code/package, and other metrics. The metrics may be provided, for example, as numerical values.

As noted above, the CAB tracking module 740 may utilize the reporting system of the project task system 700. The CAB tracking module 740 may thus present a reporting screen at the interface. The reporting screen may allow a user to specify various criteria with which to select the change records for the report including, for example, a date range. The reporting interface may also allot a user to select (e.g., via a dropdown list) a filter with which to select change records for the report. For example, a user may select the production install date property as the filter and provide a desired production install date with which to filter the change records for the report. The resulting report may include one or more change records based on the criteria provided by the user, which may be exported to, for example, a spreadsheet document.

### Data Movement Module

The project task system may also include a data movement module 865 for tracking the movement of data between various locations of the system, e.g., between servers, databases, etc. The data movement module 865 maintains information to track and audit the movement of data including, for example, information that indicates the source of data, the destination of data, which individual moved the data, why the data was moved, and how the data was moved. The data movement module 865 thus helps to ensure data linkages are not lost when databases are moved between different servers. The data movement module 865 may utilize the email notification system of the project task system 700 to automatically provides email notifications system for tracking the movement of data and databases.

The data movement module 865 may provide an interface for viewing data movement records. The interface may present, for example, an identifier for a data model record, a name for the data movement record (e.g., the name of the database), a part name for the data movement record (e.g. a database table), a status (e.g., active, new) for the data movement record, and a review status (e.g., under review, draft), and an approved/denied date. The data movement module 865 may also provide an interface for adding and configuring data movement records. The interface for adding data movement records may permit a user to add data movement interface information including, for example, the name of the database the data will be moved from, the names of one or more of the data movement parts (e.g., the name of the database table), the source data analysis platform, the target data analysis platform, the purpose (e.g., data deliverable), the origin environment, the target retention value and target retention time period (e.g., 10 days), the data movement type, (e.g., full), the CDC indicator, the technology used, the holiday process (e.g., no run on holiday), the calendar type used (e.g., bank calendar), the frequency (e.g., daily), the normal run day (e.g., on Friday, on Monday, on Saturday, on Sunday), the exception frequency, the estimated start time (e.g., 10:00 PM), the first execution date, and the status of the data movement part (e.g., active).

The data movement module 865 may also provide an interface for listing a schedule of data movement jobs, e.g., in a listing or table that includes at least some of the information described above. The data movement module 865 may also provide an interface for listing the contact messages relating to data movement. The contact messages relating to data movement may identify, for example, the category associated with the contact, the name of the contact, the role of the contact, the email address of the contact, the primary and secondary phone number, the support days for the contact (e.g., Mon.-Sun.), the support hours for the contact (e.g., 00:00-23:59), the type of contact (e.g., internal), the group name for the contact, and the like.

The data movement module 865 may also provide an interface for approving a data movement. The interface may permit a user to select a data movement record for approval. The data movement approval interface may present information relating to the data movement record including, for example, the status of the data movement (e.g., under review), CAB number, the install date, the approved date, the issue ticket number, the source platform, the target platform, the origin environment, the data movement type, the technology, the tables selected, the frequency (e.g., daily), a CDC indicator. The data movement interface may also include a button to generate and save an agreement number for the data movement record. The data movement interface may also include a section to provide options for an SLA analyst to approve or deny the data movement. For example, the approval options may include “approve,” “conditional approve,” “deny,” and “awaiting information.”

### Resiliency Tracking

The project task system 700 may also include a resiliency tracking module 870 to manage information regarding the recovery of an application. The resiliency tracking module 870 provides information for a recovery point and recovery time objectives as well as information on the high level details of the application. The resiliency tracking module 870 may also be configured to provide information regarding analytic and trending analyses of the database and data regarding resiliency. For example, during a production outage, the resiliency tracking module may provide analytical information relating to the extent of the damage caused by the outage; the estimated timeframe that databases, data, and applications may be recovered from the outage; information regarding what data has been lost; information regarding what data may be recovered; and information regarding the regulatory requirements and possible fines associated with the outage.

The resiliency tracking module 870 may provide an interface for creating and configuring a resiliency tracker. The resiliency tracking module 870 may automatically populate some of the resiliency information for the resiliency tracker. The resiliency tracker information may include, for example, the CAB number, the install date, the created date, the issue ticket number, the project name, the modified date, the EPE tracking date, clarity information, the individual that modified the resiliency information, the CACP approved date, the data analysis environment, the tracker status, the application short name, the application long name, and the AIT number.

The resiliency tracking module 870 may also be configured to prompt a user for additional information regarding the resiliency tracker. A resiliency tracker may be created and configured for multiple applications. The resiliency tracking module 870 may provide various interfaces for collecting information regarding the resiliency tracker including a questionnaire, ABARS information, and comments. The questionnaire interface may prompt a user for information relating to the resiliency tracker including, for example, an AIT recovery time objective (RTO), e.g., low (>48); an AIT recovery plan objective (RPO), e.g., low (>48); information regarding any regulatory impacts; a link to an application technical recovery plan; information regarding any data movements associated with the resiliency tracker; and information regarding any tables/views associated with the resiliency tracker. The resiliency tracker may display a grid listing the associated tables/views and corresponding information, e.g., the name of the database, the table view, and the type (e.g., static, control, others). In this way, any table information that is impacted in the CAB may be available for display in one place. The interface may include a button to add tables/views to the list, including input elements to select the database, table/view, and status.

The resiliency tracking module 870 may additionally be configured to receive ABARS information from the user. Multiple ABARS records may be associated with the resiliency tracker, and the interface may include input elements for adding and configuring sets of ABARS information. The interface may also include a list of the sets of ABARS information associated with the resiliency tracker. ABARS information may include, for example, the statement of record (SOR) name, a file name, a file purpose, a file location LPAR, the name of a backup job, and the name of a restore job.

Once the resiliency tracker is submitted, the resiliency tracker function 870 may assign the resiliency tracker to a DR analyst and a DR status may be assigned. The DR status may change during the review process. Example DR statuses may include, for example, “under review” to indicate a resiliency team is reviewing the resiliency tracker, “awaiting information” to indicate that the resiliency tracker is pending until the project team will provide additional information, “feedback provided” to indicate that the project team has provided the additional information and the resiliency tracker is pending for the resiliency team to review, “completed” to indicate that the review is completed, “on hold” to indicate the review is on hold, and “deleted” to indicate that the resiliency tracker has been deleted.

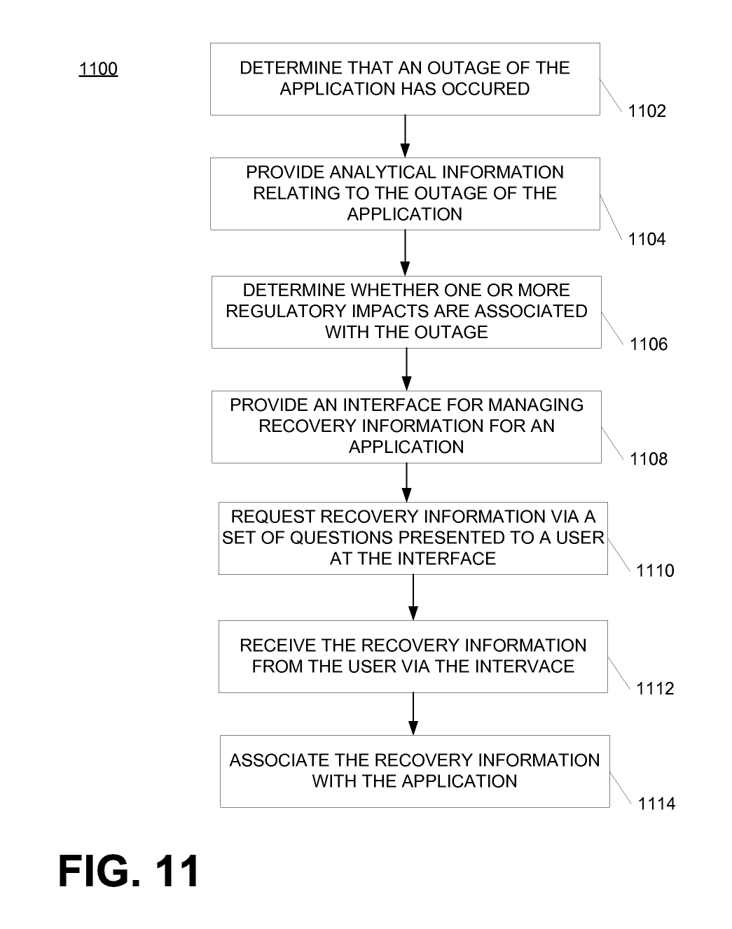

FIG. 11 illustrates a flow diagram of an example process in accordance with aspects of this invention for resiliency tracking 1100. The example resiliency tracking process 1100 may be implemented by one or more systems, devices, or computer readable media as described herein. The order of the steps depicted in FIG. 11 may be rearranged, one or more steps may be repeated in sequential and/or non-sequential order, and/or one or more steps may be omitted. Further, other steps may be added to the process 1100.

The resiliency tracking process 1100 includes a step 1102 of determining that an outage of the application has occurred. The resiliency tracking process 1100 may also include another step 1104 that includes providing analytical information relating to the outage of the application. The resiliency tracking process 1100 may include another step 1106 of determining whether one or more regulatory impacts are associated with the outage. The resiliency tracking process 1100 may also include a step 1108 of providing an interface for managing recovery information for an application. The resiliency tracking process 1100 also includes a step 1110 of requesting recovery information via a set of questions presented to a user at the interface. The resiliency tracking process 1100 may also include a step 1112 of receiving the recovery information from the user via the interface. The resiliency tracking process 1100 may also include a step 1114 of associating the recovery information with the application.

### Search Module

The project tracking system 700 may also include a searching module 875 for performing searches on the project tracking system. The searching module 875 may provide an interface that includes, for example, a centralized production support calendar to display holidays, finance days, and planned system outages. The searching module 875 may enable users to perform searches relating to SOR, relating to data movement (e.g., jobs, feeding systems, and definition details).

Because application details are stored, e.g., in database records, the searching function may thus reduce the time to search for application details, e.g., in a matter of moments. In this way, individuals may rely on the project tracking system 700 to perform their own searches to find desired information relating to the applications.

### Review Module

The project tracking system 700 may additionally include a review module 880 that automates an SLA review process for an application. The review process implemented by the review module 880 may be based on, e.g., the SLA approval date. The review module 880 may be configured to verify the delivery times of an application and provide routing of application to appropriate contacts for renegotiation times are not being met. Individuals may also use the SLA review module 880 to keep static data in an operational database (such as an inventory database) up to date and current (e.g., SOR contact names, SOR manager, production support names, and the like).

In this regard, the review module 880 may initiate an annual SLA review. The review module 880 may provide an interface that permits a reviewer to provide approval information for the SLA review. The review module 880 may also be configured to flag an SLA for mandatory review. The review module 880 may also initiate a confirmation process that generates a request to confirm that previously recorded contact information is accurate. The review module may provide an interface that enables reviewers to provide feedback, direct a user to a contact associated with the SLA review, and confirm their information. The review module may also enable user to flag SLAs required for mandatory review. In this way the review module provides improved data quality and productivity due to the automated verification steps.

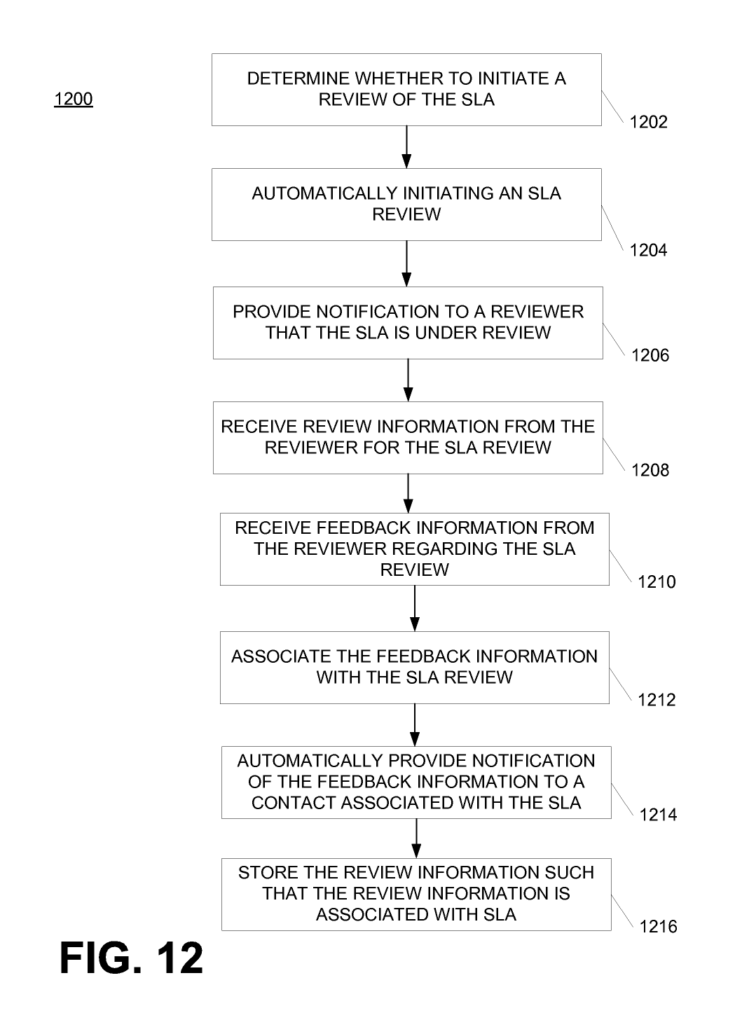

FIG. 12 illustrates a flow diagram of an example process in accordance with aspects of this invention for managing reviews of SLAs 1200. The example SLA review process 1200 may be implemented by one or more systems, devices, or computer readable media as described herein. The order of the steps depicted in FIG. 12 may be rearranged, one or more steps may be repeated in sequential and/or non-sequential order, and/or one or more steps may be omitted. Further, other steps may be added to the process 1200.

The SLA review process 1200 includes a step 1202 of determining whether to initiate a review of the SLA. The SLA review process 1200 may also include another step 1204 that includes automatically initiating an SLA review. The SLA review process 1200 may include another step 1206 of providing notification to a reviewer that the SLA is under review. The SLA review process 1200 may also include a step 1208 of receiving review information from the reviewer for the SLA review. The SLA review process 1200 also includes a step 1210 of receiving feedback information from the reviewer regarding the SLA review. The SLA review process 1200 may also include a step 1212 of associating the feedback information with the SLA review. The SLA review process 1200 may also include a step 1214 of automatically providing notification of the feedback information to a contact associated with the SLA. The SLA review process 1200 may also include a step 1216 of storing the review information such that the review information is associated with the SLA.

### PMT SLA Tracking

The project task system 700 may further include a PMT SLA tracking module 885 that provides a web interface to track and view SLA misses and other project support tasks. The PMT SLA tracking module 885 may automatically provide notification messages in response to events as well as reports based on the profile of the project. The PMT SLA tracking module 885 also provides an interface for tracking remediation tasks as well as trending and tracking mechanisms for project key performance and follow-up tasks to track to closure, e.g., trending and tracking indicating the reasons project teams missed their SLA, which SLAs may be affected, and which applications may be affected by the missed SLA.

### Trending & Tracking Reporting

The project tracking system may include a trending/tracking reporting module 890. The trending/tracking reporting module 890 may provide an interface for production support reports. In this way, the trending/tracking reporting module 890 may provide information for future predictive analysis of the number and types of resources an enterprise may need. The trending/tracking reporting module 890 may combine and integrates application definitions with operational run in order to provide an analysis of production performance and output using real-time data and metrics. The trending/tracking reporting module 890 may be configured to convert existing project reports and create new trending and tracking reports, e.g., hierarchically-structured metric scorecards. In this way, the trending/tracking reporting module reduces the risk of platform issues going undetected. Users may also create individualized reports using the trending/tracking reporting module 890.

### EOM & Outage Reporting/Tracking

The project tracking system 700 may also include an EOM and outage reporting/tracking module 895. The EOM/outage reporting/tracking module 895 may provide an interface interface for EOM reports and application outages while incorporating the multiple platforms. Load teams, project and platform support teams may utilize the EOM/outage reporting/tracking module 895 to produce various reports. Comments and information may be consolidated when producing the reports. In this way, the EOM/outage reporting/tracking module 895 may reduce project time to consolidate and cross-check information as well as reduce platform support team to consolidate load team information. The EOM/outage reporting/tracking module 895 may also provide faster EOM and Teradata outage reporting across platforms.

### Project Tracking System

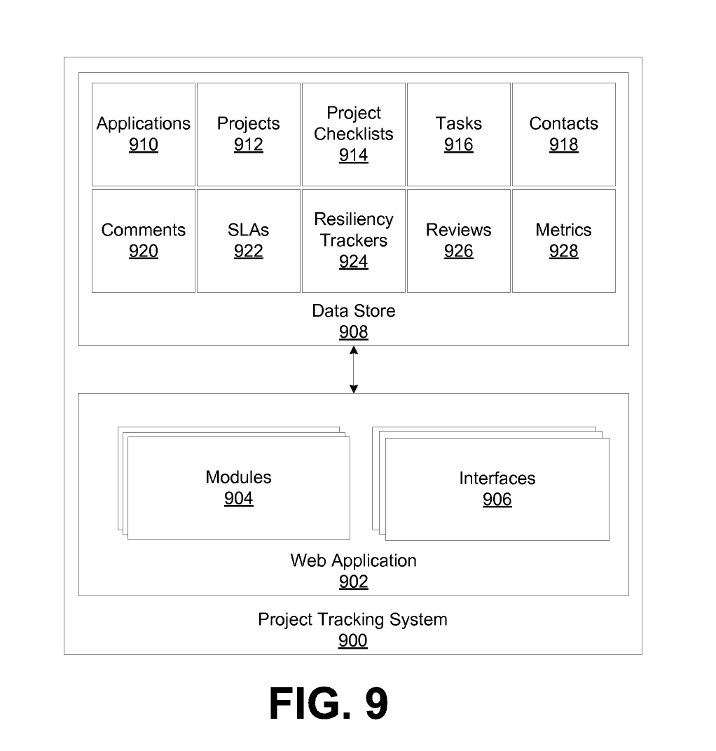

As discussed throughout this description above the project tracking system may be implemented as a web application that is accessible from various terminals via a network such as a LAN (e.g., an intranet) or a WAN (e.g., the Internet). The web application may reside at a web server that provides various interfaces for managing the production support processes described above via the network. FIG. 9 is an example of an implementation of a project tracking system 900 for managing and tracking projects. The project tracking system may include a web application 902 that includes one or more of the various modules 904 described above. The web application may also provide one or more of the various interfaces 906 described above.

The system may also include a back-end data store 908 for storing information and data relating to and associated with projects. The data store may be a database that implements a project tracking data model. The database may thus store the information and data as database records in various tables according to the project tracking data model. As seen in FIG. 9, the database may store. e.g., application records 910, project records, 912, project checklist records 914, task records 916, contact records 918, comment records 920, SLA records 922, resiliency tracker records 924, review records 926, and metrics records 928. The project tracking data model may also define various attributes for these records and establish various relationships between these records such as those attributes and relationships discussed above.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A system for project management comprising:
a project checklist module configured to receive project information associated with a new project and identify a project type based on the project information, wherein the project checklist module further is configured to link a set of applications associated with the project information for the new project, wherein the project information is a service level agreement;
a project tracker module configured to track and update the project information for the new project;
a service level agreement module configured to electronically submit service level agreements, distribute service level agreements, and approve service level agreements;
a table of changes module configured to generate a comparison table that tracks column and row level changes for service level agreement changes, additions, or decommissions, wherein the table of changes module generates an audit trail of changes for service level agreements in the form of the comparison table; and
a task updates module configured to prompt creation of a new set of tasks for the project type and associate the new set of tasks with the new project and the service level agreement, wherein the task updates module further provides real-time information to view, trend, and track tasks, types of tasks, and the completion of tasks.

2. The system of claim 1, wherein the project checklist module further controls the type of new project and sends notifications based on the project information and an automated contacts summary that is linked to the set of applications.

3. The system of claim 1, wherein the project tracker module is further configured to provide real-time information for the project information and further provide feedback based on the project information and an automated contacts summary that is linked to the set of applications

4. The system of claim 1, wherein the task definition module is further configured to present a project questionnaire for the new project and receive project information in response to a request for answers to the questionnaire.

5. The system of claim 1 further comprising a task interface that displays a list of tasks assigned to a user.

6. The system of claim 1, wherein the electronic submitting of service level agreements utilizes electronic signatures.

7. The system of claim 1 wherein service level agreement module provides trending and tracking for the SLA approval that includes at least one of: who approved the SLAs, how many SLAs were approved, or how many SLAs were negotiated.

8. The system of claim 1 wherein service level agreement module is further configured to build efficiency models to staff projects in the future properly and automates this staffing with an automated contacts summary that is linked to the set of applications.

9. A computer-implemented method for project management comprising:
receiving, by a project task system, project information associated with a new project, wherein the project information is a service level agreement;
identifying, by the project task system, a project type for the new project based, at least in part, on the project information;
linking, by the project task system, a set of applications associated with the project information and the set of tasks for the new project;
tracking and updating, by the project task system, the project information for the new project;
electronically submitting, by the project task system, service level agreements, distributing service level agreements, and approving service level agreements;
generating, by the project task system, a comparison table that tracks column and row level changes for service level agreement changes, additions, or decommissions, wherein the comparison table provides an audit trail of changes for the service level agreement;
creating, by the project task system, a new set of tasks for the new project based on the project type and associating the new set of tasks with the new project and the service level agreement; and
providing, by the project task system, real-time information to view, trend, and track the tasks, types of tasks, and the completion of tasks.

10. The computer-implemented method of claim 9 further comprising:
controlling the type of new project and sending notifications based on the project information and an automated contacts summary that is linked to the set of applications.

11. The computer-implemented method of claim 9 further comprising:
providing real-time information for the project information and further providing feedback based on the project information and an automated contacts summary that is linked to the set of applications.

12. The computer-implemented method of claim 9 further comprising presenting a project questionnaire for the new project wherein the project information for the project is received in response to a request for answers to the project questionnaire.

13. The computer-implemented method of claim 9 further comprising providing a task interface that displays a list of tasks assigned to a user.

14. The computer-implemented method of claim 9 further comprising providing trending and tracking for the SLA approval that includes at least one of: who approved the SLAs, how many SLAs were approved, or how many SLAs were negotiated.

15. The computer-implemented method of claim 9 further comprising building efficiency models to staff projects in the future properly and automating this staffing with an automated contacts summary that is linked to the set of applications.

16. A non-transitory computer readable medium having computer-executable instructions stored thereon that, when executed by a processor, cause the processor to perform steps for project management, the steps comprising:
receiving, by a project task system, project information associated with a new project, wherein the project information is a service level agreement;
identifying, by the project task system, a project type for the new project based, at least in part, on the project information;
linking, by the project task system, a set of applications associated with the project information and the set of tasks for the new project;
tracking and updating, by the project task system, the project information for the new project;
electronically submitting, by the project task system, service level agreements, distributing service level agreements, and approving service level agreements;
providing a contacts summary that is linked to the set of applications;
generating, by the project task system, a comparison table that tracks column and row level changes for service level agreement changes, additions, or decommissions, wherein the comparison table provides an audit trail of changes for the service level agreement;
creating, by the project task system, a new set of tasks for the new project based on the project type and associating the new set of tasks with the new project and the service level agreement; and
providing, by the project task system, real-time information to view, trend, and track the tasks, types of tasks, and the completion of tasks.

17. The non-transitory computer readable medium of claim 16 wherein the instructions, when executed by the processor, cause the processor to perform steps further comprising:
providing real-time information for the project information and further providing feedback based on the project information and the contacts summary.

18. The non-transitory computer readable medium of claim 16 wherein the instructions, when executed by the processor, cause the processor to perform steps further comprising:
controlling the type of new project and sending notifications based on the project information and the contacts summary.

19. The non-transitory computer readable medium of claim 16 wherein the instructions, when executed by the processor, cause the processor to perform steps further comprising:
providing trending and tracking for the SLA approval that includes at least one of: who approved the SLAs, how many SLAs were approved, or how many SLAs were negotiated.

20. The non-transitory computer readable medium of claim 16 wherein the instructions, when executed by the processor, cause the processor to perform steps further comprising:
building efficiency models to staff projects in the future properly and automating this staffing with the contacts summary.
